(19) United States
(12) Patent Application Publication
(10) Pub. No.: US 2008/0059671 A1
(43) Pub. Date: Mar. 6, 2008

(54) Data transfer method in a daisy chain arrangement

(75) Inventors: Thomas Blumcke, Emmendingen (DE); Frank Moritz, Freiburg (DE)

Correspondence Address: HARNESS, DICKEY & PIERCE, P.L.C., P.O. BOX 828, BLOOMFIELD HILLS, MI, 48303, US

(73) Assignee: SICK AG, Waldkirch/Breisgau (DE)

(21) Appl. No.: 11/893,048

(22) Filed: Aug. 14, 2007

(30) Foreign Application Priority Data
Aug. 30, 2006 (DE) 10 2006 040 709.1

(51) Int. Cl. G06F 13/00

(52) U.S. Cl. 710/110

(57) ABSTRACT

The present invention relates to a method for the serial transmission of data items comprising at least one start identifier and subsequent user data in a daisy chain arrangement having at least one first device, a second device connected after the first device and a third device connected after the second device. The method comprises the steps of receiving a signal comprising a start identifier from the first device by the second device, transmitting the start identifier to the third device by the second device after the recognition of the start identifier, transmitting, subsequent to the transmitting of the start identifier, of own user data, generated in the second device, to the third device by the second device, receiving the external user data from the first device following the start identifier by the second device while and/or after the second device is transmitting/has transmitted the start identifier and/or its own user data to the third device and transmitting, subsequent to the transmitting of own user data, of the received external user data to the third device by the second device.

The invention relates to a method for the serial transfer of data items in a daisy chain arrangement.

A daisy chain arrangement is understood as the chain-like sequential connection of devices capable of data communication. In this context, a following device is in each case connected to its predecessor. For example, the respective output of a device is connected to the input of a following device and, finally, the output of the last device in the daisy chain arrangement is connected to the input of the first device so that ultimately a ring structure results.

The first device of the chain frequently carries out the function of a master in such a daisy chain arrangement. Said master, for example, transmits a request for the transfer of user data to the following devices also called slaves. This request is first completely received by a slave including any data already added by a preceding slave. Subsequently, the receiving slave adds its own data and transmits them to the following slave. Finally, the last slave in the chain transmits the data packet including the data of all devices directly to the master.

In this transfer procedure, the response time, that is the time between the transmission of the request by the master and the reception of the data packet by the last device, amounts, with n slave devices present in the daisy chain arrangement, to at least the n-fold time of the time required for the transmission of the data item, including the start identifier since a device first completely receives a data item before it sends it on to a following device with its own data added.

It is the object of the invention to provide a data transmission method in a daisy change arrangement in which the time between the transmission of a request and the reception of a response is reduced.

The object is satisfied by a method having the features of claim 1 and in particular by a method for the serial transmission of data items comprising at least one start identifier and following user data in a daisy chain arrangement having at least one first device, a second device connected after the first device and a third device connected after the second device, comprising the following steps:
receiving a signal comprising a start identifier from the first device by the second device;
transmitting the start identifier to the third device by the second device after the recognition of the start identifier;
transmitting, subsequent to the transmitting of the start identifier, of own user data, generated in the second device, to the third device by the second device;
receiving external user data from the first device following the start identifier by the second device while and/or after the second device is transmitting/has transmitted the start identifier and/or its own user data to the third device;
transmitting, subsequent to the transmitting of own user data, of the received external user data to the third device by the second device.

The method in accordance with the invention is characterized in that, immediately after the reception and recognition of a start identifier from a preceding device, a device transfers this start identifier to a following device. While the receiving device is still receiving further user data following the start identifier from the preceding device, it is already transmitting its own user data to the following device subsequent to the transmitted start identifier. Directly following the transmission of its own user data, the user data received from the preceding device are sent on to the following device. For this purpose, corresponding means are provided in devices working according to this process for the short-term buffering of the received data.

The advantage with respect to known processes therefore comprises the fact that the receiving device does not only start to transmit data after it has completely received data transmitted by the preceding device, but already starts the transmission or forwarding of the user data after the recognition of the start identifier.

The daisy chain arrangement preferably includes a master device which transmits the start identifier for the first time to effect the transmission of the user data by the further devices. The master device thus requests the user data from the following devices. As a rule, the transmission of this start identifier by the master takes place without further user data of the master.

The data items occupied with user data of all further devices are advantageously transmitted to the master device to end the transmission. The user data generated by the further devices are thereby subsequently available to the master device.

In a preferred embodiment of the invention, at least two devices of the daisy chain arrangement are slave devices. Such slave devices are characterized in that they only transmit data on request, for example on request by a master device.

The transmission of the start identifier to the third device by the second device preferably takes place directly after the recognition of the start identifier by the second device.

The time required by a receiving device for the recognition of the start identifier is advantageously shorter than the time required for the transmission of a bit. In this process variant, the delay time respectively caused by a device is therefore shorter than the time required for the transmission of a bit.

The user data generated by a device preferably each have the length of one bit. This is in particular the case when only two possible states should be transmitted by this device, for example a sensor. Since it is not necessary in this case to reserve a respective complete data item for this device, the number of data to be transmitted can be further reduced. The response time to a master request is thus also reduced since in particular a single data item can be occupied by a start identifier and the user data of a plurality of devices.

The method in accordance with the invention can also be used with an asynchronous data transmission. Furthermore, the transmission of the data items can take place without address data. This is in particular of advantage when all the devices present in the daisy chain arrangement should transmit user data and a single device should not be addressed directly.

In an advantageous method variant, the transmission of a further data item to the third device by the second device takes place on the exceeding of a predetermined item length by the insertion of the user data of a second device. This in particular proves to be advantageous when the number of the devices present in the daisy chain arrangement is not known or changes and the number of the data items ultimately to be transmitted is therefore not predetermined. In this case, the last bit of a data item is transmitted into the next data item as a carry bit.

The transmission of its own identifier to the third device by the second device advantageously follows the transmission of its own user data. This identifier can serve, for example, as a control bit or a check bit or, with an unknown number of the devices present in the arrangement, for the verification of a user datum, i.e. e.g. to determine whether bit positions of a data item with the value 0 are to be interpreted as user data or as “blank” bit positions of the data item which have no longer been occupied with user data due to the reaching of the last device in the arrangement. In this case, the identifier would so-to-say serve as a “stamp” which flags the preceding own user data as such.

In a preferred embodiment, external identifiers transmitted alternately with external user data from the first device are received by the second device and subsequently the external identifiers are transmitted by the second device to the third device alternately with the external user data in the sequence of reception. The identifiers are accordingly forwarded to the following device in the same manner as the user data.

Further advantageous embodiments of the invention are set forth in the dependent claims.

The invention will be described in the following with reference to the drawings; there are shown in these:

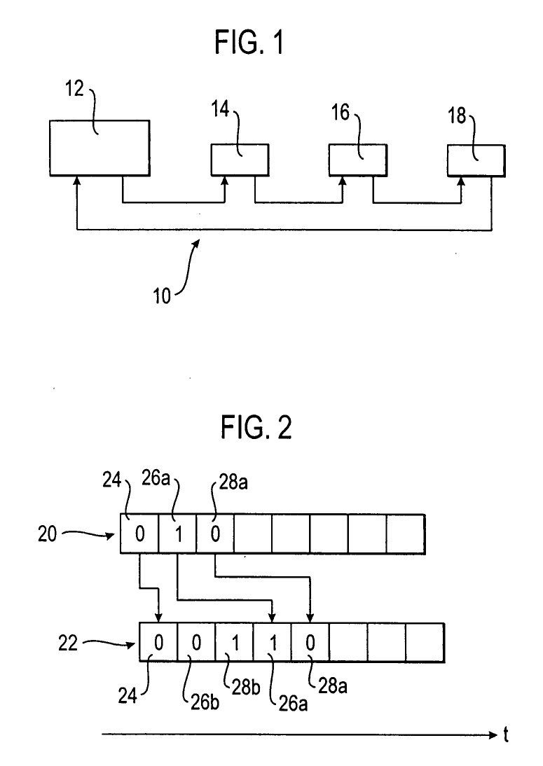

FIG. 1 a schematic representation of a daisy chain arrangement; and

FIG. 2 a schematic representation of the data received and transmitted by a device.

FIG. 1 shows a daisy chain arrangement 10 which includes a master 12 as well as first, second and third slaves 14, 16, 18. In this connection, the master 12 and the slaves 14, 16, 18 are connected sequentially such that data items transmitted by the master 12 are first received by the first slave 14, are transmitted by this to the second slave 16, are received by this and transmitted to the third slave 18 and are finally transmitted back to the master 12 by it. The transmission direction is indicated by the directions of the arrows.

In FIG. 2, date items 20 and 22 respectively received or transmitted by the second slave 16 are shown by way of example over a time axis t, with the time direction being indicated by the arrow and extending from left to right. Accordingly, in the eight-bit long data items 20, 22, the first received or transmitted bit can be found at the far left and the last received or transmitted bit can be found at the far right. The corresponding bits between the data items are marked by arrows.

The data item 20 transmitted by the first slave 14 and received by the second slave 16 therefore starts with a start identifier 24 originally transmitted by the master 12 and followed by a user bit 26a and subsequently an identifier bit 28a which were both generated by the first slave 14. The identifier bit 28a is here a check bit inverse to the user bit. The last five bits of the data item 20 are blank. The representation of stop bits possibly required for the transmission has been omitted for reasons of clarity.

The data item 22 transmitted by the second slave 16 to the third slave 18 is shown beneath the received data item 20. As can be recognized from the time displacement with respect to the received data item 20, the transmission of the data item 22 starts with a delay which is caused by the recognition of the start identifier 24 and which amounts to approximately half the time required for the transmission of a respective bit.

The user bit 26b generated by the second slave 16 is first transmitted directly after the start identifier 24. The identifier bit 28b which is also a check bit inverse to the user bit 26b and which is likewise generated by the second slave 16 follows it subsequently. Alternatively, however, a non inverted check bit can also be used. The user data previously received from the first slave 14 are transmitted in their original order subsequent to the identifier bit 28b. The user bit 26a of the first slave and the associated identifier bit 28a therefore now follow. The remaining three bits remain blank.

The data item 22 is received by the third slave 18 and finally transmitted to the master 12, with the third slave 18 in turn inserting its user bit and data bit between the start identifier 24 and the user bit 26b of the second slave.

The time which passes between the first-time transmission of the start identifier 24 by the master 12 and the reception of the last bit of the data item at the master 12 thus corresponds in the example shown here with three slaves 14, 16, 18 only to the time required for the transmission of the data item from the last slave 18 to the master 12 plus the sum of the delay times arising on the recognition of the start identifier 24 of approximately half a bit length in each case, i.e. in total to approximately 9.5 bit lengths in the example shown.

### REFERENCE NUMERAL LIST

10 daisy chain arrangement
12 master
14 first slave
16 second slave
18 third slave
20 received data item
22 transmitted data item
24 start identifier
26a, 26b user bit
28a, 28b identify bit

1. A method for the serial transmission of data items (20, 22) comprising at least one start identifier (24) and following user data (26a, 26b) in a daisy chain arrangement (10) having at least one first device (14), a second device (16) connected after the first device (14) and a third device (18) connected after the second device (16), comprising the steps:
receiving a signal comprising a start identifier (24) from the first device (14) by the second device (16);
transmitting the start identifier (24) to the third device (18) by the second device (16) after the recognition of the start identifier (24);
transmitting, subsequent to the transmitting of the start identifier (24), of own user data (26b), generated in the second device (16), to the third device (18) by the second device (16);
receiving the external user data (26a) from the first device (14) following the start identifier (24) by the second device (16) while and/or after the second device (16) is transmitting/has transmitted the start identifier (24) and/or its own user data (26a) to the third device (18);
transmitting, subsequent to the transmitting of own user data (26b), of the received external user data (26a) to the third device (18) by the second device (16).

2. A method in accordance with claim 1, characterized in that the daisy chain arrangement (10) includes a master device (12) which transmits the start identifier (24) for the first time to effect the transmission of the user data (26a, 26b) by the further devices (14, 16, 18).

3. A method in accordance with claim 2, characterized in that the data items (20, 22) occupied with user data (26a, 26b) are transmitted to end the transmission to the master device (12).

4. A method in accordance with claim 1, characterized in that at least two devices of the daisy chain arrangement (10) are slave devices (14, 16, 18).

5. A method in accordance with claim 1, characterized by the step:
transmitting the start identifier (24) to the third device (18) by the second device (16) directly after the recognition of the start identifier (24) by the second device (16).

6. A method in accordance with claim 1, characterized in that the time required by a receiving device for the recognition of the start identifier (24) is shorter than the time required for the transmission of a bit.

7. A method in accordance with claim 1, characterized in that the user data (26a, 26b) generated by a device each have the length of one bit.

8. A method in accordance with claim 1, characterized in that the data transmission is asynchronous.

9. A method in accordance with claim 1, characterized in that the transmission of the data items (20, 22) is without address data.

10. A method in accordance with claim 1, characterized by the step:
transmitting a further data item to the third device by the second device on exceeding a predetermined item length.

11. A method in accordance with claim 1, characterized by the step:
transmitting, subsequent to the transmitting of own user data (26b,) its own identifier (28b) to the third device (18) by the second device (16).

12. A method in accordance with claim 1, characterized by the steps:
receiving external identifiers (28a) transmitted alternately with external user data (26a) from the first device (14) by the second device (16); and
subsequent transmitting of the external identifiers (28a) to the third device (18) alternately with the external user data (26a) in the order of reception by the second device (16).
